(19) United States
(12) Patent Application Publication
(10) Pub. No.: US 2010/0157258 A1
(43) Pub. Date: Jun. 24, 2010

(54) PROJECTION DISPLAY SYSTEM

(76) Inventors: Shen-Huei WANG, Hsinchu City (TW); Chin-Ku LIU, Hsinchu City (TW)

Correspondence Address: Muncy, Geissler, Olds & Lowe, PLLC, 4000 Legato Road, Suite 310, FAIRFAX, VA, 22033, US

(21) Appl. No.: 12/631,499

(22) Filed: Dec. 4, 2009

(30) Foreign Application Priority Data
Dec. 18, 2008 (TW) 097149322

(51) Int. Cl. G03B 21/28

(52) U.S. Cl. 353/98

(57) ABSTRACT

A projection display system includes a full-surround screen, at least one reflective element, and a first projection unit. The full-surround screen defines an accommodation space in the shape of a column. The reflective element is disposed in the accommodation space, and the reflective element has a bottom surface and at least one side surface connected with the bottom surface, the side surface of the reflective element faces the full-surround screen. The first projection unit is used for projecting a first image beam on the side surface of the reflective element, and the side surface of the reflective element reflects the first image beam to allow the first image beam to fall upon the full-surround screen.

### CROSS REFERENCE TO RELATED APPLICATION

This application claims priority of application No. 097149322 filed in Taiwan R.O.C. on Dec. 18, 2008 under 35 U.S.C. §119; the entire contents of which are hereby incorporated by reference.

### BACKGROUND OF THE INVENTION

1. Field of the Invention

The invention relates to a projection display system, particularly to a projection display system capable of displaying a full-surround projection image.

2. Description of the Related Art

FIG. 1 shows a schematic diagram illustrating a conventional projection display device 100. Referring to FIG. 1, an emitting light beam of an optical engine 102 of the projection display device 100 is modulated by a light valve 104 to form a projection image on a screen. However, the conventional projection display device 100 may project a light beam on a planar screen 106, and thus optical arrangement of the projection display device 100 is adapted for a planar focal plane. Hence, once such projection display device 100 projects a light beam on a curved screen 108, the projection display device 100 fails to obtain accurate focusing for and competent resolution of a projection image.

### BRIEF SUMMARY OF THE INVENTION

The invention provides a projection display system, and the projection display system has excellent image resolution and is capable of displaying a full-surround projection image viewed through 360 degrees.

According to an embodiment of the invention, a projection display system includes a full-surround screen, at least one reflective element, and a first projection unit. The full-surround screen defines an accommodation space in the shape of a column. The reflective element is disposed in the accommodation space, and the reflective element has a bottom surface and at least one side surface connected with the bottom surface, the side surface of the reflective element faces the full-surround screen, and a central axis of the reflective element is substantially parallel to a central axis of the full-surround screen. The first projection unit is used for projecting a first image beam on the side surface of the reflective element, a first optical axis of the first projection unit is substantially parallel to the central axis of the reflective element, and the side surface of the reflective element is capable of reflecting the first image beam to allow the first image beam to fall upon the full-surround screen. In this embodiment, since a curved full-surround screen displays an image beam reflected by the reflective element having a curved side surface, accurate focusing for and excellent resolution of a projection image are obtained.

In one embodiment, the central axis of the reflective element substantially overlaps the central axis of the full-surround screen, and the first optical axis of the first projection unit substantially overlaps the central axis of the reflective element.

In one embodiment, the accommodation space is in the shape of a cylinder, and the reflective element is in the shape of a circular cone with a half-cone angle of 45 degrees.

In one embodiment, the accommodation space is in the shape of a prism, and the reflective element is in the shape of a pyramid.

In one embodiment, the projection display system has a first projection unit and a second projection unit. The second projection unit is disposed side by side with the first projection unit on one side of the reflective element, wherein the first projection unit is capable of projecting the first image beam on a first half of the reflective element and the second projection unit is capable of projecting a second image beam on a second half of the reflective element. In this embodiment, since different image beams from two distinct projection units are combined and directed to a single full-surround screen, projection images displayed on the full-surround screen are allowed to have better brightness and resolution.

According to another embodiment of the invention, a projection display system includes a full-surround screen, a first reflective element, a second reflective element, a first projection unit, and a second projection unit. The full-surround screen defines an accommodation space in the shape of a column. The first reflective element and the second reflective element are disposed in the accommodation space, and each of the first reflective element and the second reflective element has a bottom surface and at least one side surface connected with the bottom surface. The bottom surface of the first reflective element faces the bottom surface of the second reflective element, the side surface of the first reflective element faces the full-surround screen, and the side surface of the second reflective element faces the full-surround screen. A central axis of the first reflective element and a central axis of the second reflective element are both substantially parallel to a central axis of the full-surround screen. The first projection unit faces the side surface of the first reflective element and is capable of projecting a first image beam on the side surface of the first reflective element, an optical axis of the first projection unit is substantially parallel to the central axis of the first reflective element, and the side surface of the first reflective element is capable of reflecting the first image beam to allow the first image beam to fall upon the full-surround screen. The second projection unit faces the side surface of the second reflective element and is capable of projecting a second image beam on the side surface of the second reflective element, an optical axis of the second projection unit is substantially parallel to the central axis of the second reflective element, and the side surface of the second reflective element is capable of reflecting the second image beam to allow the second image beam to fall upon the full-surround screen. Since the projection units are opposite to each other project respective image beams on different regions of a full-surround screen, a comparatively large projection image is obtained.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a conventional projection display device.

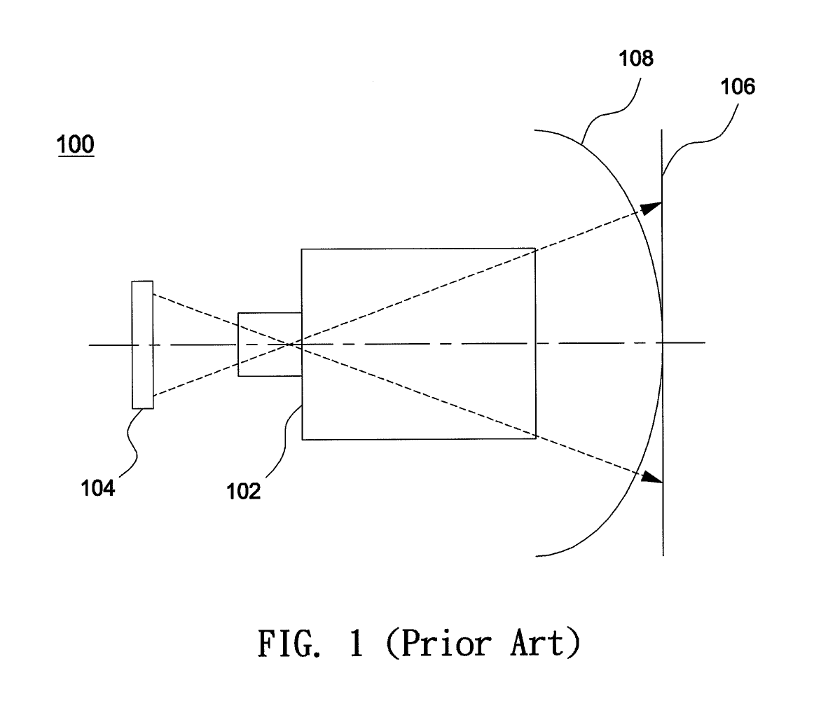

FIG. 2 shows a schematic diagram of a projection display system according to an embodiment of the invention.

FIGS. 3A and 3B are schematic diagrams illustrating image patterns respectively formed on a light valve and a full-surround screen.

FIG. 4 shows a schematic diagram of a projection display system according to another embodiment of the invention.

FIG. 5 shows a schematic diagram of a projection display system according to another embodiment of the invention.

FIG. 6 shows a schematic diagram of a projection display system according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

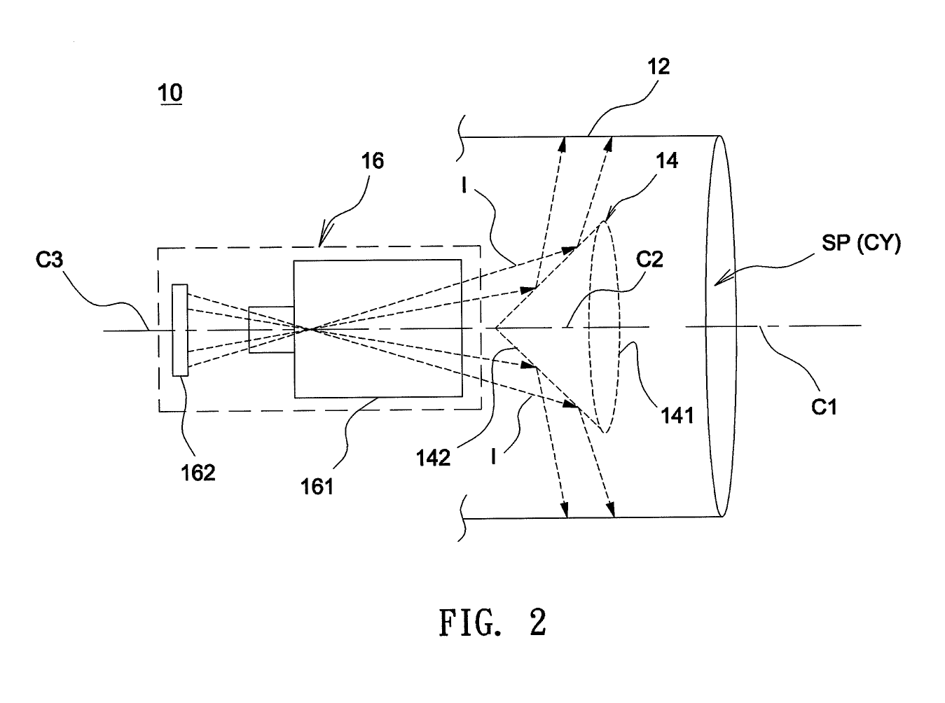

FIG. 2 shows a schematic diagram of a projection display system 10 according to an embodiment of the invention. Referring to FIG. 2, the projection display system 10 includes a full-surround screen 12, a reflective element 14, and a projection unit 16. The full-surround screen 12 defines an accommodation space SP in the shape of a cylinder CY. In other words, the full-surround screen 12 forms a side surface of the cylinder CY. The reflective element 14 is disposed in the accommodation space SP bounded by the full-surround screen 12. The reflective element 14 has a bottom surface 141 and at least one side surface 142 connected with the bottom surface 141, and the side surface 142 of the reflective element 14 faces the full-surround screen 12. Further, a central axis C2 of the reflective element 14 is substantially parallel to a central axis C1 of the full-surround screen 12. In this embodiment, the reflective element 14 is a reflective mirror in the shape of a circular cone and has a half-cone angle of 45 degrees, and the central axis C2 of the reflective element 14 substantially overlaps the central axis C1 of the full-surround screen 12. The projection unit 16 projects an image beam I on the side surface 142 of the reflective element 14, and an optical axis C3 of the projection unit 16 is substantially parallel to the central axis C2 of the reflective element 14. In this embodiment, the optical axis C3 of the projection unit 16 substantially overlaps the central axis C2 of the reflective element 14. The side surface 142 of the reflective element 14 reflects the image beam I to allow the image beam I to spread over an entire inner wall of the full-surround screen 12, so that full-surround projection image capable of being viewed through 360 degrees is formed. In this embodiment, the projection unit 16 may include a projection lens 161 and a light valve 162 such as a digital micro-mirror device (DMD) or an LCD panel. According to the above embodiment, since the curved full-surround screen 12 displays an image beam reflected by the reflective element 14 having a curved side surface, accurate focusing for and excellent resolution of a projection image are obtained.

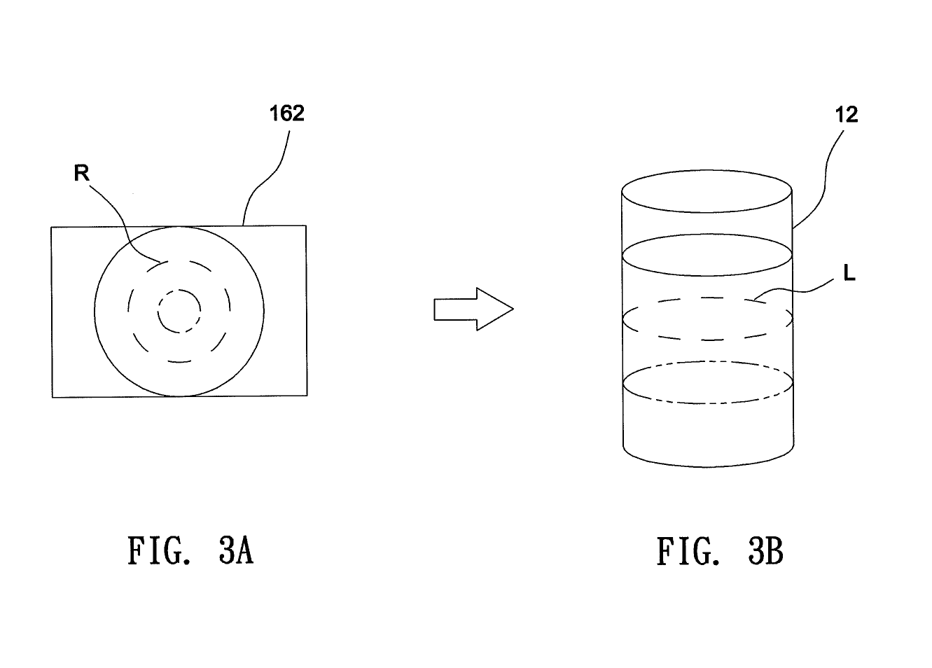

FIGS. 3A and 3B are schematic diagrams illustrating image patterns respectively formed on the light valve 162 and the full-surround screen 12. Since the light valve 162 is planar-shaped but the full-surround screen 12 is curve-shaped, raw image signals are subject to mapping transformation to carry out correct display on the full-surround screen 12 when the projection display system 10 shown in FIG. 2 projects image beams on the full-surround screen 12. For example, as shown in FIG. 3B, in order to let an observer standing in the center of the full-surround screen 12 view a straight line L on the screen, mapped pixel signals that are transformed in advance to represent an arc line R shown in FIG. 3A are input to the projection unit 16 to carry out correct display of a straight line L on the full-surround screen 12. In one embodiment, a chip built in the projection unit 16 may perform mapping transformation or scaling on raw image signals. Alternatively, the mapping transformation or scaling may be performed on raw image signals by means of software programming, and then the converted signals are fed into the projection unit 16.

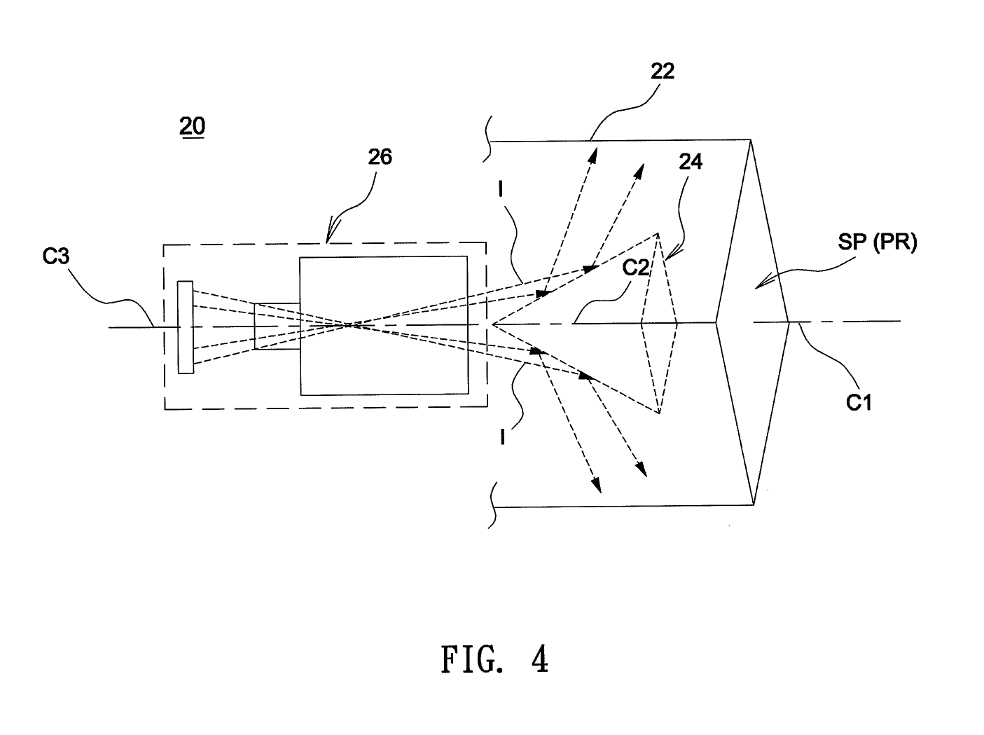

FIG. 4 shows a schematic diagram of a projection display system 20 according to another embodiment of the invention. The projection display system 20 shown in FIG. 4 is similar to the above embodiment, except that the accommodation space SP defined by a full-surround screen 22 is in the shape of a rectangular prism PR, and that the reflective element 24 is in the shape of a rectangular pyramid. Since the four-sides of the reflective element 24 (rectangular pyramid) correspond to the four-sides of the rectangular prism PR defined by the full-surround screen 22, when the projection unit 26 projects an image beam on the reflective element 24, four side surfaces of the reflective element 24 reflect the image beam I toward four side walls of the full-surround screen 22 to form a full-surround projection image capable of being viewed through 360 degrees. Hence, the shape of the reflective element and the full-surround screen is not limited in embodiments of the invention, and a full-surround projection image capable of being viewed through 360 degrees is obtained as long as the shape correspondence exists between the reflective element and the full-surround screen. For example, a cylinder full-surround screen corresponds to a reflective element in the shape of a circular cone, and a full-surround screen in the shape of rectangular prism corresponds to a reflective element in the shape of a rectangular pyramid.

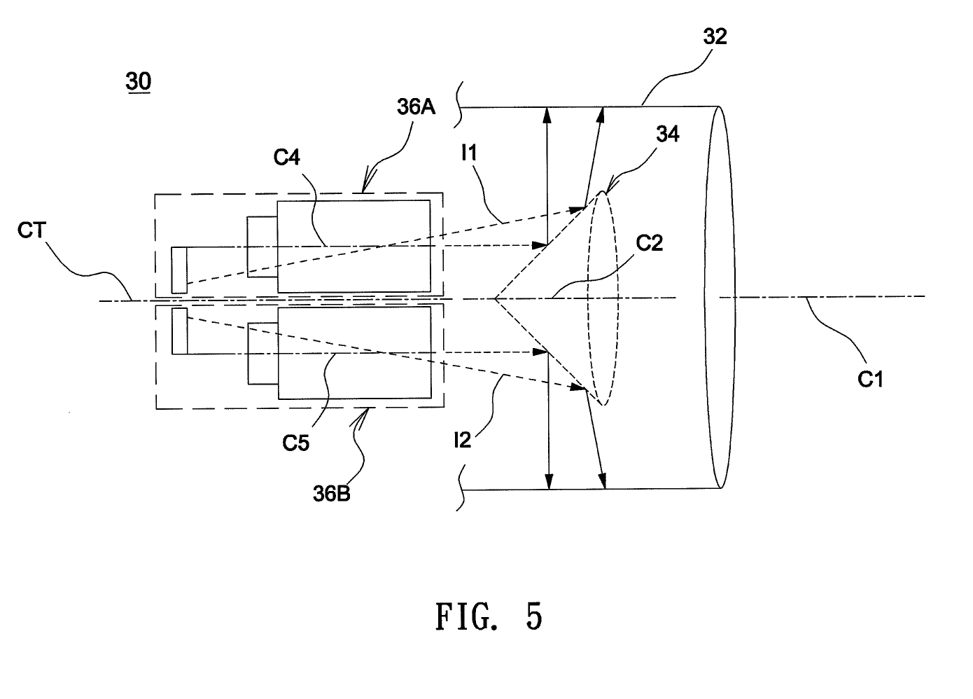

FIG. 5 shows a schematic diagram of a projection display system 30 according to another embodiment of the invention. Referring to FIG. 5, the projection display system 30 includes a full-surround screen 32, a reflective element 34, a first projection unit 36A, and a second projection unit 36B. The first projection unit 36A and the second projection unit 36B are disposed side by side on one side of the reflective element 34. The first projection unit 36A has an optical axis C4, the second projection unit 36B has an optical axis C5, and a center line CT between the optical axis C4 and the optical axis C5 overlaps a central axis C2 of the reflective element 34. Hence, a first image beam I1 is projected on an upper half of the reflective element 34 by the first projection unit 36A, and a second image beam I2 is projected on a lower half of the reflective element 34 by the second projection unit 36B. According to this embodiment, since different image beams from two distinct projection units 36A and 36B are combined and directed to a single full-surround screen 32, projection images displayed on the full-surround screen 32 are allowed to have better brightness and resolution.

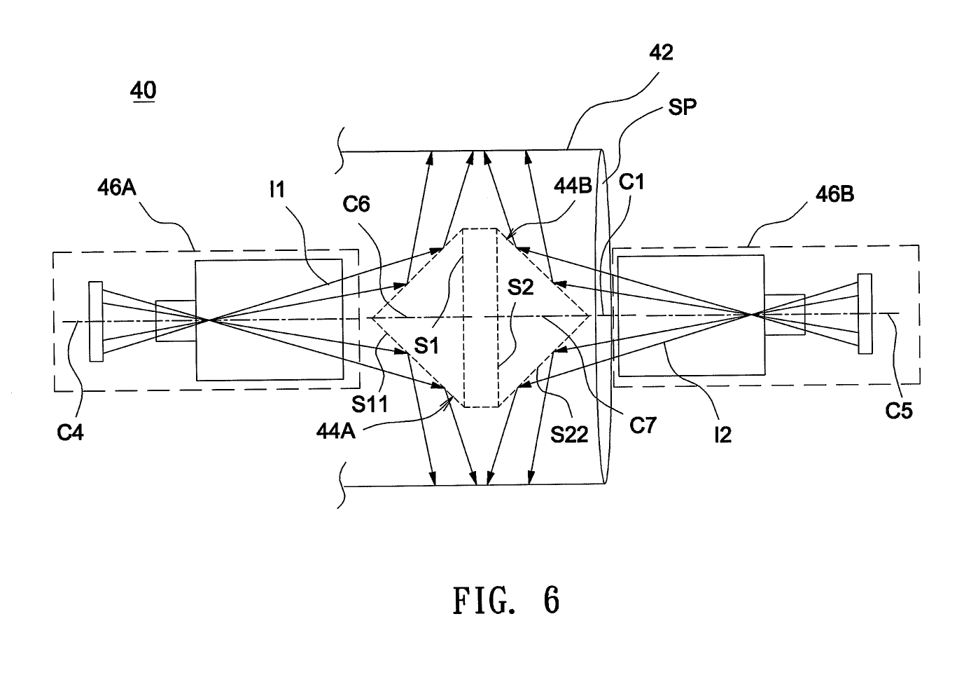

FIG. 6 shows a schematic diagram of a projection display system 40 according to another embodiment of the invention. Referring to FIG. 6, the projection display system 40 includes a full-surround screen 42, a first reflective element 44A, a second reflective element 44B, a first projection unit 46A, and a second projection unit 46B. The full-surround screen 42 defines an accommodation space SP in the shape of a column (such as a cylinder or a prism), and the first reflective element 44A and the second reflective element 44B are disposed in the accommodation space SP. The first reflective element 44A has a bottom surface S1 and at least one side surface S11, and the second reflective element 44B has a bottom surface S2 and at least one side surface S22. The bottom surface S1 of the first reflective element 44A faces the bottom surface S2 of the second reflective element 44B, and the side surface S11 of the first reflective element 44A and the side surface S22 of the second reflective element 44B both face the full-surround screen 42. A central axis C6 of the first reflective element 44A and a central axis C7 of the second reflective element 44B are both parallel to a central axis C1 of the full-surround screen 42. In this embodiment, the central axis C6 of the first reflective element 44A and the central axis C7 of the second reflective element 44B both substantially overlap the central axis C1 of the full-surround screen 42. The first projection unit 46A faces the side surface S11 of the first reflective element 44A and is disposed on one side of the first reflective element 44A opposite the second reflective element 44B. The second projection unit 46B faces the side surface S22 of the second reflective element 44B and is disposed on one side of the second reflective element 44B opposite the first reflective element 44A. The first projection unit 46A projects a first image beam I1 on the side surfaces S11 of the first reflective element 44A, and an optical axis C4 of the first projection unit 46A is substantially parallel to the central axis C6 of the first reflective element 44A. All side surfaces S11 of the first reflective element 44A reflect the first image beam I1 to allow the first image beam I1 to fall upon the full-surround screen 42, thus forming a part of a full-surround projection image capable of being viewed through 360 degrees. In comparison, the second projection unit 46B projects a second image beam I2 on the side surfaces S22 of the second reflective element 44B, and an optical axis C5 of the second projection unit 46B is substantially parallel to the central axis C7 of the second reflective element 44B. All side surfaces S22 of the second reflective element 44B reflect the second image beam I2 to allow the second image beam I2 to fall upon the full-surround screen 42, thus forming the remainder of the full-surround projection image capable of being viewed through 360 degrees. In this embodiment, the optical axis C4 of the first projection unit 46A substantially overlaps the central axis C6 of the first reflective element 44A, and the optical axis C5 of the second projection unit 46B substantially overlaps the central axis C7 of the second reflective element 44B. Since the projection units 46A and 46B are opposite to each other project respective image beams on different regions of the full-surround screen 42, a comparatively large projection image is obtained. In this embodiment, the full-surround screen may be in the shape of a cylinder, and each of the first reflective element 44A and the second reflective element 44B may be a circular cone-shaped mirror having a half-cone angle of 45 degrees. Alternatively, the full-surround screen may be in the shape of a prism, and each of the first reflective element 44A and the second reflective element 44B may be a rectangular pyramid-shaped mirror.

Note, in the above embodiments, the central axis of the full-surround screen, the central axis of the reflective element, and the optical axis of the projection unit substantially overlap with each other. However, this is not limited, and a full-surround projection image capable of being viewed through 360 degrees is obtained as long as these central axes and optical axes are substantially parallel to each other.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection display system, comprising:
a full-surround screen defining an accommodation space in the shape of a column;
at least one reflective element disposed in the accommodation space, the reflective element having a bottom surface and at least one side surface connected with the bottom surface, and the side surface of the reflective element facing the full-surround screen; and
a first projection unit capable of projecting a first image beam on the side surface of the reflective element, wherein the side surface of the reflective element is capable of reflecting the first image beam to allow the first image beam to fall upon the full-surround screen.

2. The projection display system as claimed in claim 1, wherein a central axis of the reflective element is substantially parallel to a central axis of the full-surround screen and a first optical axis of the first projection unit is substantially parallel to the central axis of the reflective element.

3. The projection display system as claimed in claim 2, wherein the central axis of the reflective element substantially overlaps the central axis of the full-surround screen and the first optical axis of the first projection unit substantially overlaps the central axis of the reflective element.

4. The projection display system as claimed in claim 1, wherein the accommodation space is in the shape of a cylinder and the reflective element is in the shape of a circular cone.

5. The projection display system as claimed in claim 4, wherein the reflective element has a half-cone angle of 45 degrees.

6. The projection display system as claimed in claim 1, wherein the accommodation space is in the shape of a prism and the reflective element is in the shape of a pyramid.

7. The projection display system as claimed in claim 6, wherein the accommodation space is in the shape of a rectangular prism and the reflective element is in the shape of a rectangular pyramid.

8. The projection display system as claimed in claim 1, wherein the projection unit comprises a mapping processor used to perform mapping transformation on raw image signals fed into the projection unit.

9. The projection display system as claimed in claim 1, further comprising a second projection unit disposed side by side with the first projection unit on one side of the reflective element, wherein the first projection unit is capable of projecting a first image beam on a first half of the reflective element and the second projection unit is capable of projecting a second image beam on a second half of the reflective element.

10. The projection display system as claimed in claim 9, wherein the first projection unit has a first optical axis, the second projection unit has a second optical axis, and a center line between the first optical axis and the second optical axis substantially overlaps a central axis of the reflective element.

11. A projection display system, comprising:
a full-surround screen defining an accommodation space in the shape of a column;
a first reflective element and a second reflective element disposed in the accommodation space, each of the first reflective element and the second reflective element having a bottom surface and at least one side surface connected with the bottom surface, wherein the bottom surface of the first reflective element faces the bottom surface of the second reflective element, the side surface of the first reflective element faces the full-surround screen, and the side surface of the second reflective element faces the full-surround screen;
a first projection unit facing the side surface of the first reflective element and capable of projecting a first image beam on the side surface of the first reflective element, wherein the side surface of the first reflective element is capable of reflecting the first image beam to allow the first image beam to fall upon the full-surround screen; and
a second projection unit facing the side surface of the second reflective element and capable of projecting a second image beam on the side surface of the second reflective element, wherein the side surface of the second reflective element is capable of reflecting the second image beam to allow the second image beam to fall upon the full-surround screen.

12. The projection display system as claimed in claim 11, wherein a central axis of the first reflective element and a central axis of the second reflective element are both substantially parallel to a central axis of the full-surround screen, an optical axis of the first projection unit is substantially parallel to the central axis of the first reflective element, and an optical axis of the second projection unit is substantially parallel to the central axis of the second reflective element.

13. The projection display system as claimed in claim 12, wherein the central axis of the first reflective element substantially overlaps the central axis of the second reflective element.

14. The projection display system as claimed in claim 12, wherein the optical axis of the first projection unit substantially overlaps the central axis of the first reflective element, and the optical axis of the second projection unit substantially overlaps the central axis of the second reflective element.

15. The projection display system as claimed in claim 12, wherein the central axis of the first reflective element, the optical axis of the first projection unit, the central axis of the second reflective element, and the optical axis of the second projection unit all substantially overlap the central axis of the full-surround screen.

16. The projection display system as claimed in claim 11, wherein the accommodation space is in the shape of a cylinder and each of the first reflective element and the second reflective element is in the shape of a circular cone.

17. The projection display system as claimed in claim 16, wherein each of the first reflective element and the second reflective element has a half-cone angle of 45 degrees.

18. The projection display system as claimed in claim 11, wherein the accommodation space is in the shape of a prism and each of the first reflective element and the second reflective element is in the shape of a pyramid.

19. The projection display system as claimed in claim 18, wherein the accommodation space is in the shape of a rectangular prism and each of the first reflective element and the second reflective element is in the shape of a rectangular pyramid.
